(19) United States
(12) Patent Application Publication
(10) Pub. No.: US 2026/0029830 A1
(43) Pub. Date: Jan. 29, 2026

(54) PROCESS PROPOSAL DEVICE, PROCESS PROPOSAL METHOD, AND PROCESS PROPOSAL PROGRAM

(71) Applicant: Hitachi, Ltd., Tokyo (JP)

(72) Inventors: Kazuhiro ABE, Tokyo (JP); Seunghwan PARK, Tokyo (JP)

(21) Appl. No.: 19/243,868

(22) Filed: Jun. 20, 2025

(30) Foreign Application Priority Data
Jul. 24, 2024 (JP) 2024-118297

(51) Int. Cl. G06F 1/28; G05B 15/02

(52) U.S. Cl. CPC G06F 1/28; G05B 15/02

(57) ABSTRACT

A process proposal device includes: a processor; and a storage unit, wherein the storage unit holds evaluation information that associates, with a DR (Demand-Response) priority score, each of an adjustable amount of power consumption for production of a product in a factory, a residence time of the product, and personnel required for production of the product, and the processor: acquires process information indicating a plurality of processes for producing the product, a past production plan, and sensor data acquired in response to the past production plan; calculates, on the basis of the process information and the past production plan, an adjustable amount of the power consumption in each of the processes included in the process information; and calculates the residence time in each of the processes on the basis of the past production plan and the sensor data.

### CLAIM OF PRIORITY

The present application claims priority from Japanese patent application JP 2024-118297 filed on Jul. 24, 2024, the content of which is hereby incorporated by reference into this application.

### TECHNICAL FIELD

The present invention relates to a technology proposing a method for effectively dealing with demand response in a factory.

### BACKGROUND ART

As the introduction of variable renewable energy such as solar power generation and wind power generation has expanded, problems relating to power supply-and-demand adjustment have become apparent, and the Ministry of Economy, Trade and Industry has also promoted calls and efforts relating to power supply-and-demand adjustment. One example of such countermeasures is demand response (hereinafter, also referred to as “DR”) in which an electric power consumer responds to a call to adjust their power consumption on the basis of a power supply-and-demand balance. There are two types of demand response: a lower DR that suppresses a rapid increase in power demand, and an upper DR that actively uses surplus renewable energy.

The background art of this technical field includes the following prior art. PTL 1 (JP 2016-081074 A) includes a demand response determination means that specifies, from among facilities installed in industrial facilities, a normally-responding facility that is capable of always responding to power suppression and a time-transferable facility that is capable of responding to power suppression by changing an operating time, and that calculates a suppressible amount of power that can be suppressed by each facility, that determines whether or not power of a suppression amount designated on the basis of the suppressible amount can be suppressed, and that, in a case where it is determined that power can be suppressed, outputs information indicating an instruction to change an operation state of the facility as required to satisfy the designated suppression amount and/or indicating the determination result.

### CITATION LIST

### Patent Literature

PTL 1: JP 2016-081074 A

### SUMMARY OF INVENTION

### Technical Problem

Currently, DR in a factory involves cooperating with large customers in specific businesses in which power demand can be easily predicted in advance in a predetermined time zone in which a power shortage is assumed. However, where DR in the future is concerned, it is desirable to create a larger adjustment force and stabilize power supply and demand through the participation of not only large customers in specific businesses but also factories in a wide range of fields. Until now, the process for performing demand response has only been selected on the basis of the priority of a work process in a factory or on output power, and it has not been possible to quantitatively evaluate whether the process should be prioritized from the outset. As the parameters necessary for an accurate evaluation, in addition to power consumption, bottlenecks caused by a production capacity disparity of each process or the personnel required may be considered, but there is a problem in that it is difficult to make a straightforward determination only in light of past production information, and it is difficult to specify a process for which the time required can be adjusted.

An object of the present invention is to calculate a demand response priority score with high accuracy by using sensor data to calculate a residence time of a product, and thus perform an efficient demand response.

### Solution to Problem

A representative example of the invention disclosed in the present application is as follows: That is, a process proposal device includes: a processor; and a storage unit, wherein the storage unit holds evaluation information that associates, with a demand response priority score, each of an adjustable amount of power consumption for production of a product in a factory, a residence time of the product, and personnel required for production of the product, and the processor: acquires process information indicating a plurality of processes for producing the product, a past production plan, and sensor data acquired in response to the past production plan; calculates, on the basis of the process information and the past production plan, an adjustable amount of the power consumption in each of the processes included in the process information; calculates the residence time in each of the processes on the basis of the past production plan and the sensor data; calculates the personnel required for each of the processes on the basis of the past production plan; calculates a demand response priority score for each of the processes on the basis of the adjustable amount of the power consumption, the residence time, the personnel required, and the evaluation information of each of the processes; and outputs the demand response priority score for each of the processes.

### Advantageous Effects of Invention

According to one aspect of the present invention, a demand response priority score can be accurately calculated by using sensor data to calculate the residence time of the product, thereby enabling an efficient demand response to be performed. Problems, configurations, advantageous effects, and the like other than those described above will be clarified by the following descriptions of the embodiments.

### BRIEF DESCRIPTION OF DRAWINGS

FIG. 1 is a block diagram illustrating a configuration of a process proposal device according to an embodiment of the present invention.

FIG. 2 is a block diagram illustrating a physical configuration of the process proposal device according to the embodiment of the present invention.

FIG. 3 is a flowchart illustrating an example of processing executed by the process proposal device according to the embodiment of the present invention.

FIG. 4 is a diagram illustrating an example of a score table created by the process proposal device according to the embodiment of the present invention.

FIG. 5 is a diagram illustrating an example of a factory configuration and a priority-evaluation output result according to the embodiment of the present invention.

### DESCRIPTION OF EMBODIMENTS

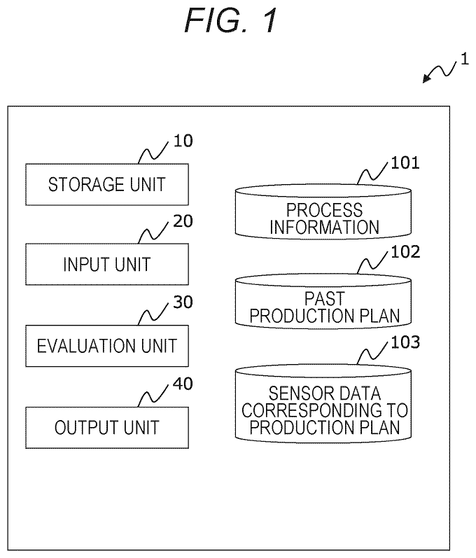

FIG. 1 is a block diagram illustrating a configuration of a process proposal device according to an embodiment of the present invention.

The process proposal device 1 according to the present embodiment includes a storage unit 10, an input unit 20, an evaluation unit 30, and an output unit 40, and generates a priority score for a process for performing a demand response in a target factory.

The storage unit 10 stores an evaluation table in which an adjustable amount of power consumption in the manufacturing of a product, the required time, and the personnel required are associated with a demand response priority score. The input unit 20 receives, as inputs, manufacturing process information, a past production plan, and sensor data corresponding to the past production plan.

The evaluation unit 30 calculates the power adjustable amount of each process in the process information on the basis of the past production plan and, on the basis of the past production plan and the sensor data, calculates the required time for the product to remain in a predetermined state. Furthermore, on the basis of the past production plan, the evaluation unit 30 calculates the personnel required for each process in the process information. The evaluation unit 30 then calculates the demand response priority score for each process in the process information on the basis of the power adjustable amount, the required time, the personnel required, and the evaluation table. The output unit 40 outputs a demand response priority score corresponding to each process.

In addition, the process proposal device 1 includes process information 101, a past production plan 102, and sensor data 103 corresponding to the production plan as data used for the processing by each functional unit. These data may be stored in an auxiliary storage device, a memory, or an external storage device.

The process information 101 includes the number of facilities pertaining to a process in a factory, facility characteristics, an operation status, a production capacity, an energy consumption amount, an inventory status of each product production process, quality information, personnel, and production cost data. The process information 101 is not necessarily limited to the information of the target factory, and may include, for example, data of a similar process of another factory. Further, the process information 101 may include data which is calculated on the basis of the data of another factory.

The past production plan 102 includes a production plan that has been implemented in the factory. The past production plan 102 reserves past operation data, but may include prediction data calculated on the basis of the reserved data. Furthermore, the past production plan 102 may include data of another factory having a similar configuration.

The sensor data 103 corresponding to the production plan indicates data acquired from sensors installed in the factory. The sensor data 103 specifically includes, for example, sensor data acquired from sensors for measuring physical states for each production process of a product, such as a temperature sensor, a vibration sensor, a humidity sensor, a pressure sensor, a camera, a motion sensor, and an RFID reader.

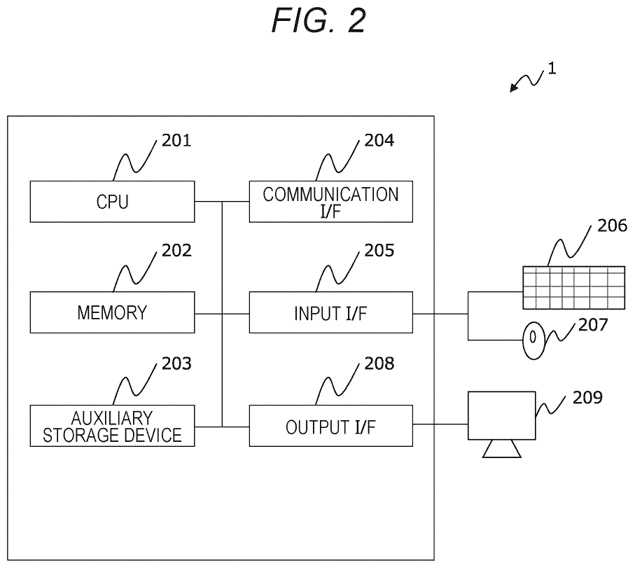

FIG. 2 is a block diagram illustrating a physical configuration of the process proposal device 1 according to the embodiment of the present invention.

The process proposal device 1 according to the present embodiment includes a computer that has a processor (CPU) 201, a memory 202, an auxiliary storage device 203, a communication interface 204, an input interface 205, and an output interface 208.

The processor 201 is an arithmetic device that executes programs stored in the memory 202, and the processor 201 implements various functions of the process proposal device 1 by executing various programs. Note that some of the processing performed by the processor 201 executing the programs may be performed by another arithmetic device.

The memory 202 includes a ROM which is a nonvolatile storage element and a RAM which is a volatile storage element. The ROM stores an immutable program and the like. The RAM is a high-speed and volatile storage element such as a DRAM, and temporarily stores a program executed by the processor 201 and data used when the program is executed.

The auxiliary storage device 203 is, for example, a large-capacity, nonvolatile storage device such as a magnetic storage device (HDD) or a flash memory (SSD). Furthermore, the auxiliary storage device 203 stores data (for example, the process information 101, the past production plan 102, the sensor data 103 corresponding to the production plan, and the like) used when the processor 201 executes a program, and stores a program (for example, an evaluation program) executed by the processor 201. That is, the program is read from the auxiliary storage device 203, loaded into the memory 202, and executed by the processor 201, thereby implementing each function of the process proposal device 1.

The communication interface 204 is a network interface device that controls communication with other devices according to a predetermined protocol.

The input interface 205 is an interface to which an input device such as a keyboard 206 or a mouse 207 is connected and which receives an input from an operator. The output interface 208 is an interface to which an output device such as the display device 209 is connected and which outputs the execution result of the program in a visually recognizable format. Note that a terminal (not illustrated) connected to the process proposal device 1 via a network may provide the input device and the output device.

The program executed by the processor 201 is provided to the process proposal device 1 via a removable medium (CD-ROM, flash memory, or the like) or a network, and is stored in the nonvolatile auxiliary storage device 203, which is a non-transitory storage medium. Therefore, the process proposal device 1 may have an interface for reading data from a removable medium.

The process proposal device 1 is a computer system configured physically on one computer or on a plurality of computers that are configured logically or physically, and may operate on a virtual computer built on a plurality of physical computer resources.

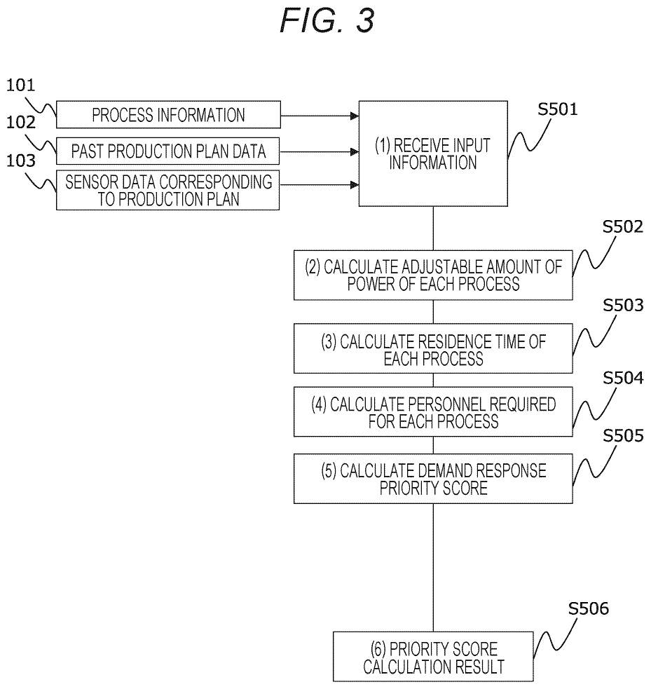

FIG. 3 is a flowchart illustrating an example of processing executed by the process proposal device 1 in the embodiment of the present invention.

The storage unit 10 has a function for storing an evaluation table (for example, a score table to be described below) in which an adjustable amount of power consumption in manufacturing a product, the required time, and the personnel required are associated with a demand response priority score.

The input unit 20 receives the process information 101 in the manufacturing of the product, the past production plan 102, and the sensor data 103 corresponding to the past production plan from the storage unit 10 as inputs (S501).

Thereafter, the evaluation unit 30 calculates a power adjustable amount of each process in the factory (S502). For example, the power adjustable amount is calculated using the process information 101 in the manufacturing of the selected product, the past production plan 102, and the sensor data 103 corresponding to the past production plan.

Next, the evaluation unit 30 calculates a residence time of each process in the factory (S503). For example, the residence time of each process is calculated using the process information 101 in the manufacturing of the selected product, the past production plan 102, and the sensor data 103 corresponding to the production plan. Note that the past production plan 102 may be production performance.

Next, the evaluation unit 30 calculates the personnel required for each process in the factory (S504). For example, the personnel required for each process is calculated using the process information 101 in the manufacturing of the selected product, the past production plan 102, and the sensor data 103 corresponding to the production plan.

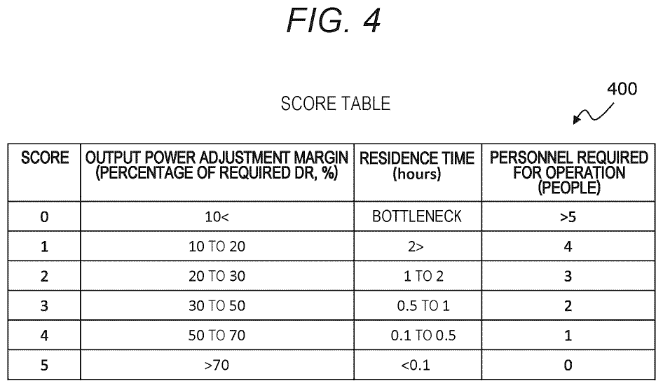

FIG. 4 is a diagram illustrating an example of a score table created by the process proposal device 1 according to the embodiment of the present invention.

The score table 400 illustrated in FIG. 4 includes evaluation indexes such as an importance level, a priority level, and a risk level for each production process of a product.

In the example of FIG. 4, a ratio to the amount of power required in the demand response is described as an output score evaluation criterion. The higher the amount of power that can be generated with respect to the required amount of power, the higher the priority of output adjustment, and the higher the score. Here, the amount of power that can be generated is, for example, a difference between the output power in a case where the process is operated and the output power in a case where the operating amount is adjusted (for example, completely stopped), and is also described as an adjustment margin of the output power or a power adjustable amount. Note that the criterion is not limited to the ratio, and may be, for example, an absolute value, an expected value, a fluctuation range, or the like, of the output power.

In the example of FIG. 4, the residence time of each process is described as the time score evaluation criterion. When demand response is executed in a process that becomes a bottleneck of the manufacturing line, the degree of influence on the decrease in the production amount is large and the score is low. On the other hand, a process having a shorter residence time has a higher priority and a higher score. This is because in a case where a process that becomes a bottleneck (that is, a process having the longest residence time in the series of processes) is temporarily stopped, the stopped time directly leads to a delay in production, whereas in a case where a process having a shorter residence time than the preceding and subsequent processes is temporarily stopped, the process may not be immediately delayed due to the residence of the preceding and subsequent processes. Note that the criterion is not limited to the residence time, and may be, for example, an operation rate or the like.

In the example of FIG. 4, the personnel required for the operation is described as the personnel score evaluation criterion. For the process, the lower the number of required personnel, the lesser the impact on shift changes, and thus the higher the priority and the higher the score. On the other hand, the more personnel required, the higher the influence on the shift change, and the lower the priority and the lower the score because it is not preferable. Note that the criterion is not limited to the personnel required, and may be, for example, whether or not a special qualification is necessary, or replacement personnel, and so forth.

Next, the evaluation unit 30 calculates a demand response priority score for each process in the factory (S505). For example, the demand response priority score for each process is calculated using the process information 101 in the manufacturing of the selected product, the past production plan 102, the sensor data 103 corresponding to the past production plan, and the score table. The score is calculated, for example, on the basis of the following equation.

(Evaluation function)=(Output power score)×(Output power weight)+(Time score)×(Time weight)+(Personnel score)×(Personnel weight)

Here, the weight attached to each term can be appropriately set according to the circumstances of each factory and the like. For example, the output power weight may be increased in a case where the highest priority is given to responding to a DR request, the time weight may be increased in a case where it is desired to minimize the influence on the production, or the personnel weight may be increased in a case where it is difficult to change the personnel.

When the evaluation unit 30 generates the priority score, the output unit 40 is activated to execute output processing.

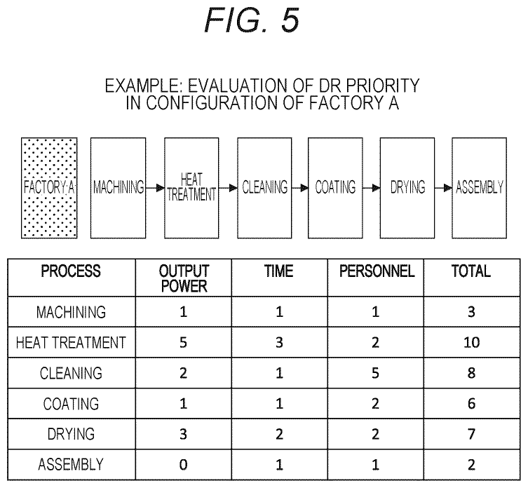

FIG. 5 is a diagram illustrating an example of a factory configuration and a priority-evaluation output result according to the embodiment of the present invention.

FIG. 5 illustrates processing, heat treatment, cleaning, painting, drying, and assembly as processes for manufacturing a product in a factory A, and illustrates values obtained by calculating an adjustable amount of output power, a residence time, and scores of required personnel in each process and by summing the calculated values for each process. As a result, because the score for the heat treatment process is the highest, it is estimated that the adjustment for most efficiently responding to the demand response can be performed by stopping the heat treatment process.

In this example, a simple sum (that is, an evenly weighted sum) is illustrated, but as described above, the score for each item, namely, the adjustable amount of the output power, the residence time, and the personnel required may be arbitrarily weighted. For example, when attention is paid to the personnel required, the score for the cleaning process is the highest. Therefore, if the weight of the personnel required is increased and the score for each process is calculated, the score for the cleaning process may be the highest.

In the above example, the scores of the respective items of the adjustable amount of the output power, the residence time, and the personnel required are weighted, but the scores of the respective processes may be weighted. For example, in a case where there is a process that is likely to be stopped due to the circumstances of a factory and a process which there is no desire to stop as much as possible, the weight of the former process may be set to be large.

The output unit 40 outputs the priority calculation result for each process in the factory (S506).

Although the Examples are output in a table, the Examples are not limited to a table, and may instead be output in a bar graph or the like, for example.

Note that the process proposal device 1 may perform an output which is based on a past priority score calculation result. For example, a calculation result using machine learning which is based on a past calculation result or an output using pattern matching may be output together.

For example, the process proposal device 1 may further hold past process information and a demand response priority score for each of the processes calculated in the past, and may learn the past process information, the past production plan, the sensor data acquired in response to the past production plan, and the demand response priority score for each of the processes calculated in the past to generate, from the process information, a model for calculating the demand response priority score for each of the processes. The process proposal device 1 may then, on the basis of the generated model, calculate a demand response priority score for each of the processes.

The process proposal device score is capable of evaluating scores using, as input data, sensors enabling the capture of detailed factory information and, by considering not only the output but also time and personnel as parameters, is capable of outputting processes for which the demand response should be quantitatively executed. Because effective supply and demand adjustment is easily implemented, a willingness by the factory to participate will increase, and thus the generation of more negawatts is to be expected.

Moreover, a system according to an embodiment of the present invention may be configured as follows:

(1) A process proposal device (for example, the process proposal device 1) includes: a processor (for example, the processor 201); and a storage unit (for example, the storage unit 10 or the memory 202 and the auxiliary storage device 203 that realize the storage unit), wherein the storage unit holds evaluation information (for example, the score table 400) that associates, with a demand response priority score, each of an adjustable amount of power consumption for production of a product in a factory, a residence time of the product, and the personnel required for production of the product, and the processor: acquires (for example, S501) process information indicating a plurality of processes for producing the product, a past production plan, and sensor data acquired in response to the past production plan; calculates (for example, S502), on the basis of the process information and the past production plan, an adjustable amount of the power consumption in each of the processes included in the process information; calculates (for example, S503) the residence time in each of the processes on the basis of the past production plan and the sensor data; calculates (for example, S504) the personnel required in each of the processes on the basis of the past production plan; calculates (for example, S505) a demand response priority score for each of the processes on the basis of the adjustable amount of the power consumption, the residence time, the personnel required, and the evaluation information of each of the processes; and outputs (for example, S506) the demand response priority score for each of the processes.

As a result, it is possible to perform an efficient demand response in consideration of not only the adjustable amount of power consumption but also the retention time of the product and the personnel required.

(2) In the process proposal device according to (1) above, in the evaluation information, the demand response priority score is set such that the demand response priority score becomes higher as the adjustable amount of the power consumption is larger, the demand response priority score becomes higher as the residence time is shorter, and the demand response priority score becomes higher as the personnel required is smaller.

As a result, a process in which the adjustable amount of power consumption is large, a process in which the residence time is short, and a process in which the number of personnel required is small are easily selected as targets of demand response, and an efficient demand response having a small impact on production activities and a large amount of power adjustment can be performed.

(3) In the process proposal device according to (2) above, on the basis of the evaluation information, the processor specifies the demand response priority score corresponding to the adjustable amount of the power consumption in each of the processes, the demand response priority score corresponding to the residence time in each of the processes, and the demand response priority score corresponding to the personnel required in each of the processes, and the processor calculates the demand response priority score for each of the processes by performing computation in which the specified demand response priority score is weighted.

As a result, a process for which the amount of power adjustment is large, a process for which the residence time is short, and a process for which the number of personnel required is small are easily selected as targets for the demand response, and further, weighting according to the circumstances of the factory becomes possible, thus enabling an efficient demand response to be performed.

(4) In the process proposal device according to (1) above, the process information includes information specifying the plurality of processes, and further includes at least one of the number of facilities pertaining to each of the plurality of processes, facility characteristics, an operation status, a production capacity, an energy consumption amount, an inventory status, quality information, or a production cost.

Consequently, the demand response priority score can be calculated accurately.

(5) In the process proposal device according to (1) above, the sensor data includes data indicating a physical state of each of the processes as measured by at least one of a temperature sensor, a vibration sensor, a humidity sensor, a pressure sensor, a camera, a motion sensor, or an RFID reader.

Consequently, the demand response priority score can be calculated accurately.

(6) In the process proposal device according to (1) above, the storage unit further holds past process information and a demand response priority score for each of the processes calculated in the past and, by learning the past process information, the past production plan, sensor data acquired in correspondence with the past production plan, and the demand response priority score for each of the processes calculated in the past, the processor generates a model for calculating the demand response priority score for each of the processes from the process information and, on the basis of the model, calculates a demand response priority score for each of the processes.

Consequently, the demand response priority score can be calculated accurately.

Note that the present invention is not limited to or by the above-described embodiment and includes various modifications. For example, the above-described embodiment has been described in detail to facilitate understanding of the present invention, and the present invention is not necessarily limited to or by an embodiment having all the configurations described. In addition, part of the configuration of one embodiment can be replaced with the configuration of another embodiment, and the configuration of the other embodiment can also be added to the configuration of the one embodiment. Moreover, it is possible to add other configurations to some of the configurations of each embodiment, or to delete or substitute other configurations.

Moreover, some or all of the above-described configurations, functions, processing units, processing means, and the like may be implemented by hardware, for example, by a design using an integrated circuit. Furthermore, each of the above-described configurations, functions, and the like may be implemented by software as a result of the processor parsing and executing a program that implements the respective functions. Information such as programs, tables, and files for implementing each function can be stored in a storage device such as a nonvolatile semiconductor memory, a hard disk drive, or a solid state drive (SSD), or on a computer-readable non-transitory data storage medium such as an IC card, an SD card, or a DVD.

Moreover, control lines and information lines that are considered necessary for the sake of the description are illustrated, and not all the control lines and information lines required for implementation are illustrated. In practice, almost all the configurations may be considered to be interconnected.

### REFERENCE SIGNS LIST

1 process proposal device
10 storage unit
20 input unit
30 evaluation unit
40 output unit
101 process information
102 past production plan
103 sensor data corresponding to production plan
201 CPU
202 memory
203 auxiliary storage device
204 communication I/F
205 input I/F
206 keyboard
207 mouse
208 output I/F
209 display

1. A process proposal device comprising:
a processor; and
a storage unit,
wherein the storage unit holds evaluation information that associates, with a demand response priority score, each of an adjustable amount of power consumption for production of a product in a factory, a residence time of the product, and personnel required for production of the product, and
the processor:
acquires process information indicating a plurality of processes for producing the product, a past production plan, and sensor data acquired in response to the past production plan;
calculates, on the basis of the process information and the past production plan, an adjustable amount of the power consumption in each of the processes included in the process information;
calculates the residence time in each of the processes on the basis of the past production plan and the sensor data;
calculates the personnel required for each of the processes on the basis of the past production plan;
calculates a demand response priority score for each of the processes on the basis of the adjustable amount of the power consumption, the residence time, the personnel required, and the evaluation information of each of the processes; and
outputs the demand response priority score for each of the processes.

2. The process proposal device according to claim 1, wherein, in the evaluation information, the demand response priority score is set such that the demand response priority score becomes higher as the adjustable amount of the power consumption is larger, the demand response priority score becomes higher as the residence time is shorter, and the demand response priority score becomes higher as the personnel required is smaller.

3. The process proposal device according to claim 2, wherein
on the basis of the evaluation information, the processor specifies the demand response priority score corresponding to the adjustable amount of the power consumption in each of the processes, the demand response priority score corresponding to the residence time in each of the processes, and the demand response priority score corresponding to the personnel required for each of the processes, and
the processor calculates the demand response priority score for each of the processes by performing computation in which the specified demand response priority score is weighted.

4. The process proposal device according to claim 1, wherein the process information includes information specifying the plurality of processes, and further includes at least one of the number of facilities pertaining to each of the plurality of processes, facility characteristics, an operation status, a production capacity, an energy consumption amount, an inventory status, quality information, or a production cost.

5. The process proposal device according to claim 1, wherein the sensor data includes data indicating a physical state of each of the processes as measured by at least one of a temperature sensor, a vibration sensor, a humidity sensor, a pressure sensor, a camera, a motion sensor, or an RFID reader.

6. The process proposal device according to claim 1, wherein
the storage unit further holds past process information and a demand response priority score for each of the processes calculated in the past, and
by learning the past process information, the past production plan, sensor data acquired in correspondence with the past production plan, and the demand response priority score for each of the processes calculated in the past, the processor generates a model for calculating the demand response priority score for each of the processes from the process information and, on the basis of the model, calculates a demand response priority score for each of the processes.

7. A process proposal method to be executed by a process proposal device, the process proposal device having a processor and a storage unit,
the storage unit holding evaluation information that associates, with a demand response priority score, each of an adjustable amount of power consumption for production of a product in a factory, a residence time of the product, and personnel required for production of the product,
the process proposal method comprising steps in which the processor:
acquires process information indicating a plurality of processes for producing the product, a past production plan, and sensor data acquired in response to the past production plan;
calculates, on the basis of the process information and the past production plan, an adjustable amount of the power consumption in each of the processes included in the process information;
calculates the residence time in each of the processes on the basis of the past production plan and the sensor data;
calculates the personnel required for each of the processes on the basis of the past production plan;
calculates a demand response priority score for each of the processes on the basis of the adjustable amount of the power consumption, the residence time, the personnel required, and the evaluation information of each of the processes; and
outputs the demand response priority score for each of the processes.

8. A process proposal program for controlling a process proposal device, the process proposal device having a processor and a storage unit,
the storage unit holding evaluation information that associates, with a demand response priority score, each of an adjustable amount of power consumption for production of a product in a factory, a residence time of the product, and personnel required for production of the product,
the process proposal program causing the processor to execute steps of:
acquiring process information indicating a plurality of processes for producing the product, a past production plan, and sensor data acquired in response to the past production plan;
calculating, on the basis of the process information and the past production plan, an adjustable amount of the power consumption in each of the processes included in the process information;
calculating the residence time in each of the processes on the basis of the past production plan and the sensor data;
calculating the personnel required for each of the processes on the basis of the past production plan;
calculating a demand response priority score for each of the processes on the basis of the adjustable amount of the power consumption, the residence time, the personnel required, and the evaluation information of each of the processes; and
outputting the demand response priority score for each of the processes.
